(19) United States
(12) Patent Application Publication
(10) Pub. No.: US 2018/0250679 A1
(43) Pub. Date: Sep. 6, 2018

(54) APPARATUS AND METHOD FOR A MODULAR ROCK CRUSHER

(71) Applicant: Kolberg-Pioneer, Inc., Yankton, SD (US)

(72) Inventors: Gary Engel, Yankton, SD (US); Joe Rust, Yankton, SD (US)

(73) Assignee: Kolberg-Pioneer, Inc., Yankton, SD (US)

(21) Appl. No.: 15/909,177

(22) Filed: Mar. 1, 2018

Related U.S. Application Data
(60) Provisional application No. 62/466,399, filed on Mar. 3, 2017.

(51) Int. Cl. B02C 1/02; B02C 23/08

(52) U.S. Cl. CPC B02C 1/025; B02C 23/08

(57) ABSTRACT

A rock crusher having a base frame with a rear section, an eccentric shaft assembly which is mounted on the base frame, and a common tension assembly which is housed in the rear section of the base frame. In the preferred embodiments of the rock crusher, the rear section of the base frame is configured to house a toggle plate/wedge assembly or a tramp iron relief system. A method for converting a rock crusher between a toggle plate/wedge adjust assembly and a tramp iron relief system.

### CROSS-REFERENCES TO RELATED APPLICATIONS/PATENTS

This application relates back to and claims the benefit of priority from U.S. Provisional Application for Patent Ser. No. 62/466,399 titled “Modular Crusher” and filed on Mar. 3, 2017.

### FIELD OF THE INVENTION

The present invention relates generally to apparatuses and methods for rock crushers, and particularly to apparatuses and methods for jaw crushers.

### BACKGROUND AND DESCRIPTION OF THE PRIOR ART

It is known to use apparatuses and methods to crush rocks. Conventional apparatuses and methods, however, suffer from one or more disadvantages. For example, conventional apparatuses and methods either have a toggle plate/wedge adjust assembly or a tramp iron relief system. Conventional apparatuses and methods cannot be easily converted between a toggle plate/wedge adjust assembly and a tramp iron relief system. Conventional apparatuses and methods are also undesirably large and expensive. Conventional apparatuses and methods also do not indicate the position of the rock crusher in the absence of a full control system.

It would be desirable, therefore, if an apparatus and method for a rock crusher could be provided that would be capable of using either a toggle plate/wedge adjust assembly or a tramp iron relief system. It would also be desirable if such an apparatus and method for a rock crusher could be provided that would easily be converted between a toggle plate/wedge adjust assembly and a tramp iron relief system. It would be further desirable if such an apparatus and method for a rock crusher could be provided that would be more compact and less expensive. It would be still further desirable if such an apparatus and method for a rock crusher could be provided that would indicate the position of rock crusher in the absence of a full control system.

### Advantages of the Preferred Embodiments of the Invention

Accordingly, it is an advantage of the preferred embodiments of the invention claimed herein to provide an apparatus and method for a rock crusher that can use either a toggle plate/wedge adjust assembly or a tramp iron relief system. It is also an advantage of the preferred embodiments of the invention claimed herein to provide an apparatus and method for a rock crusher that is easily converted between a toggle plate/wedge adjust assembly and a tramp iron relief system. It is another advantage of the preferred embodiments of the invention claimed herein to provide an apparatus and method for a rock crusher that is more compact and less expensive. It is yet another advantage of the preferred embodiments of the invention claimed herein to provide an apparatus and method for a rock crusher that indicates the position of the rock crusher in the absence of a full control system.

Additional advantages of the preferred embodiments of the invention will become apparent from an examination of the drawings and the ensuing description.

### Explanation of the Technical Terms

As used herein, the term “actuator” means any device, mechanism, assembly or combination thereof that is adapted to move or be moved between a retracted position and an extended position so as to impart a mechanical force. The term “actuator” includes without limitation linear actuators, rotary actuators, hydraulic cylinders, hydraulic rotary actuators, pneumatic cylinders, springs and the like.

### SUMMARY OF THE INVENTION

The apparatus of the invention comprises a rock crusher having a base frame with a rear section, an eccentric shaft assembly which is mounted on the base frame, and a common tension assembly which is housed in the rear section of the base frame. In the preferred embodiments of the rock crusher, the rear section of the base frame is configured to house a toggle plate/wedge assembly or a tramp iron relief system.

The method of the invention comprises a method for converting a rock crusher between a toggle plate/wedge adjust assembly and a tramp iron relief system. The preferred method comprises providing a rock crusher having a base frame with a rear section, an eccentric shaft assembly which is mounted on the base frame, and a common tension assembly which is housed in the rear section of the base frame. In the preferred embodiments of the rock crusher, the rear section of the base frame is configured to house a toggle plate/wedge assembly or a tramp iron relief system. The preferred method also comprises converting the rock crusher between a toggle plate/wedge adjust assembly and a tramp iron relief system.

### BRIEF DESCRIPTION OF THE DRAWINGS

The presently preferred embodiments of the invention are illustrated in the accompanying drawings, in which like reference numerals represent like parts throughout, and in which:

FIG. 1 is a sectional right side view of the preferred embodiment of the rock crusher base in accordance with the present invention.

FIG. 2 is a perspective view of the base frame of the preferred rock crusher base illustrated in FIG. 1.

FIG. 3 is a sectional view of the eccentric assembly of the preferred rock crusher base illustrated in FIGS. 1-2.

FIG. 4 is a bottom view of the common tension assembly of the preferred rock crusher base illustrated in FIGS. 1-3.

FIG. 5 is a sectional left side view of the preferred rock crusher base illustrated in FIGS. 1-4 shown with a toggle plate/wedge adjust assembly.

FIG. 6 is a sectional view of the preferred toggle plate/wedge adjust assembly illustrated in FIG. 5 taken along line B-B of FIG. 5.

FIG. 7 is a sectional detail view of the preferred toggle plate/wedge adjust assembly illustrated in FIGS. 5-6.

FIG. 8 is a front view of the preferred toggle plate of the toggle plate/wedge adjust assembly illustrated in FIGS. 5-7.

FIG. 9 is a perspective view of the preferred toggle block guide of the toggle plate/wedge adjust assembly illustrated in FIGS. 5-8.

FIG. 10 is a perspective view of the preferred toggle block of the toggle plate/wedge adjust assembly illustrated in FIGS. 5-9.

FIG. 11 is a perspective view of the preferred adjusting wedge of the toggle plate/wedge adjust assembly illustrated in FIGS. 5-10.

FIG. 12 is a front view of the preferred wear seat of the toggle plate/wedge adjust assembly illustrated in FIGS. 5-11.

FIG. 13 is a front view of the preferred wear seat retainer of the toggle plate/wedge adjust assembly illustrated in FIGS. 5-12.

FIG. 14 is a sectional left side view of the preferred rock crusher base illustrated in FIGS. 1-4 shown with a tramp iron relief system.

FIG. 15 is a sectional view of the preferred tramp iron relief system illustrated in FIG. 14 taken along line B-B of FIG. 14.

FIG. 16 is a sectional view of the preferred tramp iron relief system illustrated in FIGS. 14-15 taken along line C-C of FIG. 14.

FIG. 17 is a perspective view of the preferred mounting block of the tramp iron relief system illustrated in FIGS. 14-16.

FIG. 18 is a front view of the preferred actuator assembly of the tramp iron relief system illustrated in FIGS. 14-17.

FIG. 19 is a right side view of the preferred actuator assembly of the tramp iron relief system illustrated in FIGS. 14-18.

FIG. 20 is a perspective view of the preferred wear seat of the tramp iron relief system illustrated in FIGS. 14-19.

FIG. 21 is a front view of the preferred wear seat retainer of the tramp iron relief system illustrated in FIGS. 14-20.

FIG. 22 is a front view of the preferred position indicator assembly in accordance with the present invention.

FIG. 22A is a sectional view of the preferred position indicator assembly illustrated in FIG. 22 taken along line A-A of FIG. 22.

FIG. 23 is a side view of the preferred position indicator assembly illustrated in FIGS. 22 and 22A.

FIG. 23A is a sectional view of the preferred position indicator assembly illustrated in FIGS. 22-23 taken along line B-B of FIG. 23.

FIG. 24 is a perspective view of the preferred position indicator assembly housing illustrated in FIGS. 22-23.

FIG. 25 is a perspective view of the preferred actuator assembly of the tramp iron relief system and the preferred push pull cable of the position indicator assembly.

### DESCRIPTION OF THE PREFERRED EMBODIMENTS OF THE INVENTION

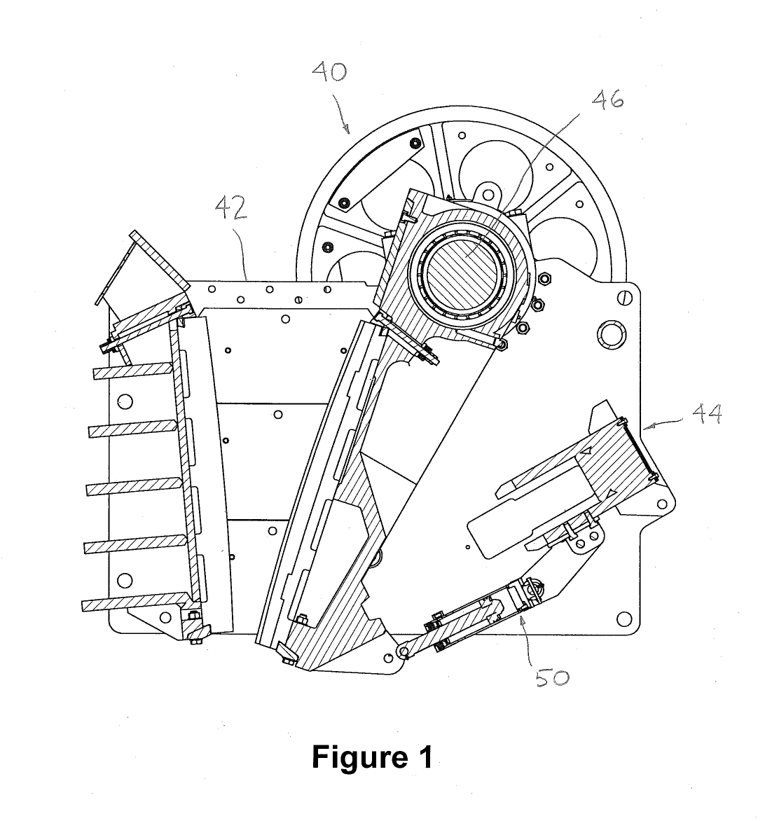

Referring now to the drawings, the preferred embodiments of the rock crusher in accordance with the present invention are illustrated by FIGS. 1 through 25. As shown in FIGS. 1-25, the preferred rock crusher is adapted to use either a toggle plate/wedge adjust assembly or a tramp iron relief system. The preferred rock crusher is also easily converted between a toggle plate/wedge adjust assembly and a tramp iron relief system. The preferred rock crusher is also more compact and less expensive. In addition, the preferred rock crusher indicates the position of the rock crusher in the absence of a full control system.

Referring now to FIG. 1, a sectional right side view of the preferred embodiment of the rock crusher base is illustrated. As shown in FIG. 1, the preferred rock crusher base is designated generally by reference numeral 40. Preferred rock crusher base 40 comprises base frame 42 having rear section 44, eccentric shaft assembly 46 which is mounted on the base frame, and common tension assembly 50 which is housed in the rear section of the base frame. In the preferred embodiments of rock crusher base 40, rear section 44 of base frame 42 is configured to house a toggle plate/wedge adjust assembly or a tramp iron relief system. While FIG. 1 illustrates the preferred configuration and arrangement of the rock crusher base, it is contemplated within the scope of the invention that the rock crusher base may be of any suitable configuration and arrangement.

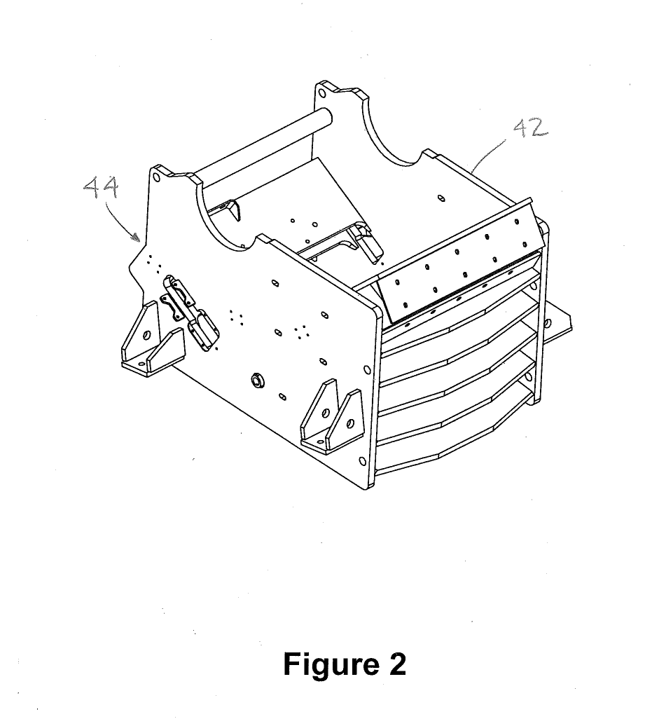

Referring now to FIG. 2, a perspective view of base frame 42 of preferred rock crusher base 40 is illustrated. As shown in FIG. 2, base frame 42 comprises rear section 44.

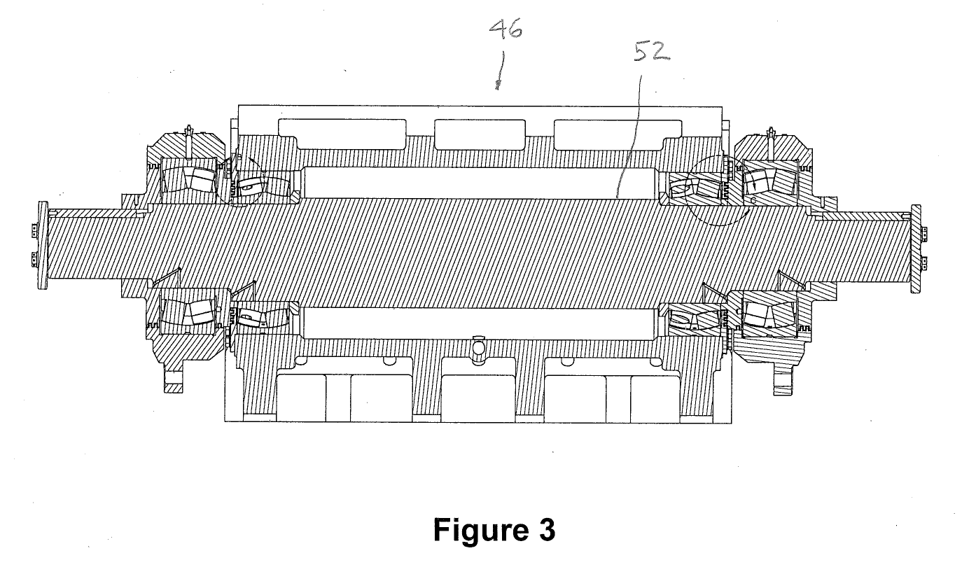

Referring now to FIG. 3, a sectional top view of eccentric assembly 46 of preferred rock crusher base 40 is illustrated. As shown in FIG. 3, preferred eccentric shaft assembly 46 comprises eccentric shaft 52.

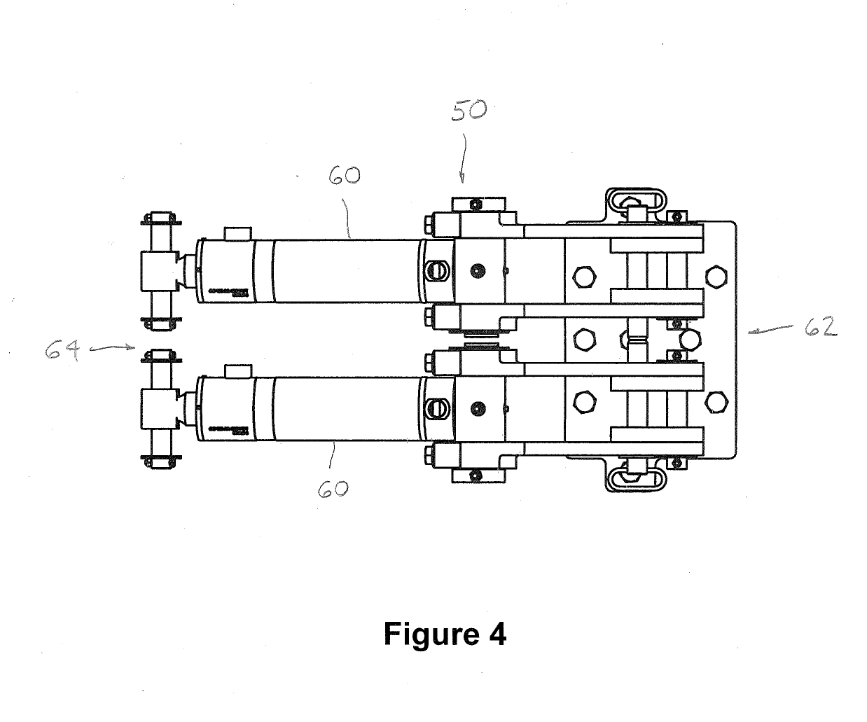

Referring now to FIG. 4, a bottom view of common tension assembly 50 of preferred rock crusher base 40 is illustrated. As shown in FIG. 4, common tension assembly 50 comprises a pair of actuators 60 which are adapted to be mounted to base frame 42 on frame end 62 and mounted to eccentric shaft assembly 46 on eccentric end 64.

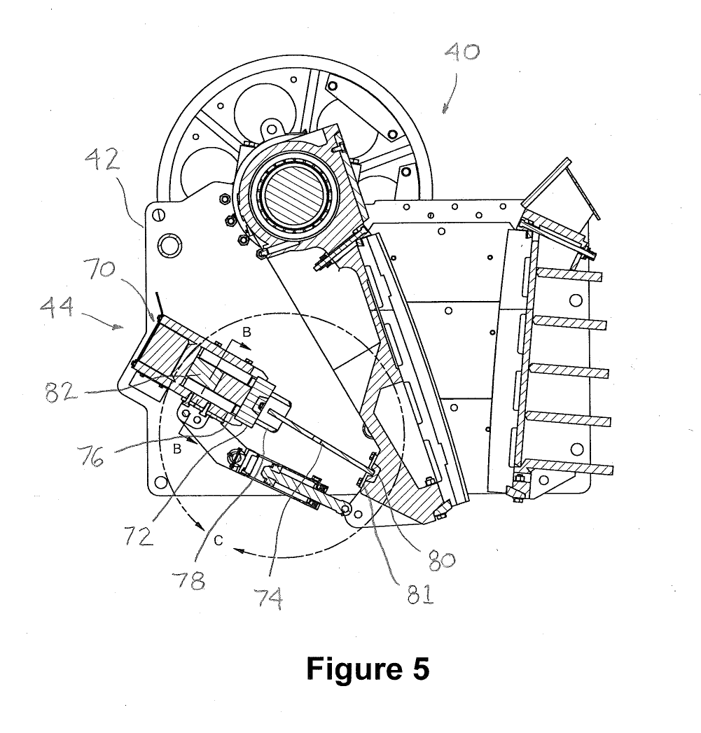

Referring now to FIG. 5, a sectional left side view of preferred rock crusher base 40 is illustrated with toggle plate/wedge adjust assembly 70. As shown in FIG. 5, preferred toggle plate/wedge adjust assembly 70 is mounted to rear section 44 of base frame 42 and eccentric shaft assembly 46. Preferred toggle plate/wedge adjust assembly 70 comprises toggle block 72, toggle plate 74, wedge guide 76, toggle block guide 78, wear seat 80, wear seat retainer 81, and wedge 82. While FIG. 5 illustrates the preferred configuration and arrangement of the toggle plate/wedge adjust assembly, it is contemplated within the scope of the invention that the toggle plate/wedge adjust assembly may be of any suitable configuration and arrangement.

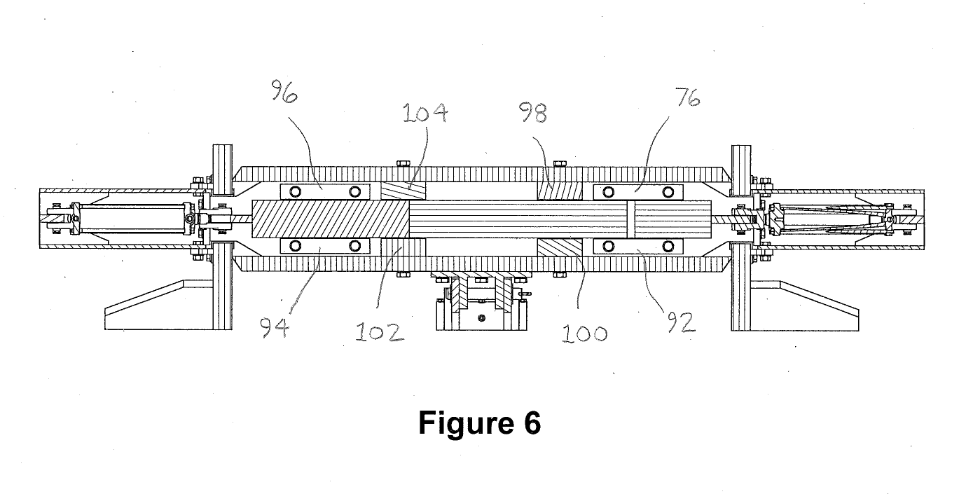

Referring now to FIG. 6, a sectional view of preferred toggle plate/wedge adjust assembly 70 taken along line B-B of FIG. 5 is illustrated. As shown in FIG. 6, preferred toggle plate/wedge adjust assembly 70 comprises wedges 82 and 84. Preferred toggle plate/wedge adjust assembly 70 further comprises an actuator such as hydraulic cylinders 86 and 88, wedge guides 76, 92, 94, and 96, and wedge alignment blocks 98, 100, 102, and 104.

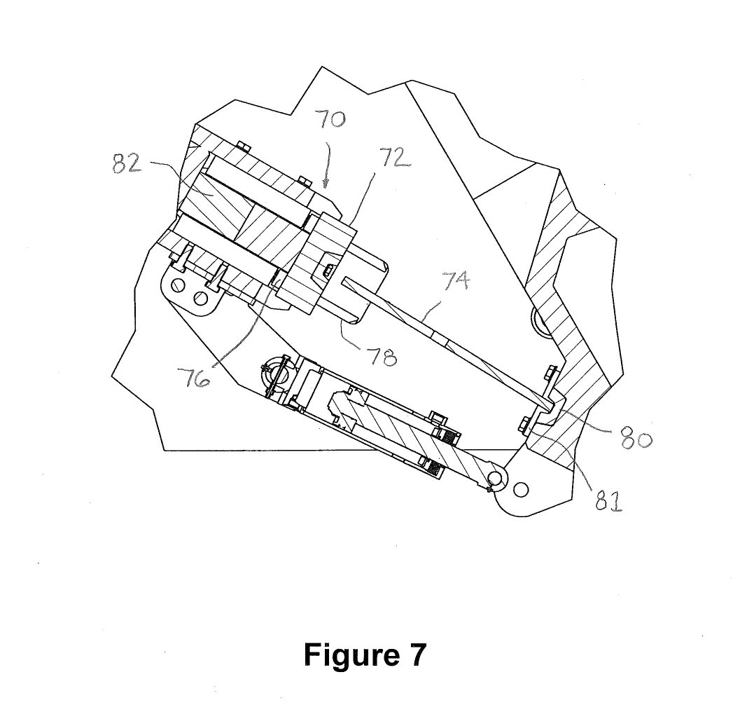

Referring now to FIG. 7, a sectional detail view of preferred toggle plate/wedge adjust assembly 70 taken along line C-C of FIG. 5 is illustrated. As shown in FIG. 7, preferred toggle plate/wedge adjust assembly 70 comprises toggle block 72, toggle plate 74, wedge guide 76, toggle block guide 78, wear seat 80, wear seat retainer 81, and wedge 82.

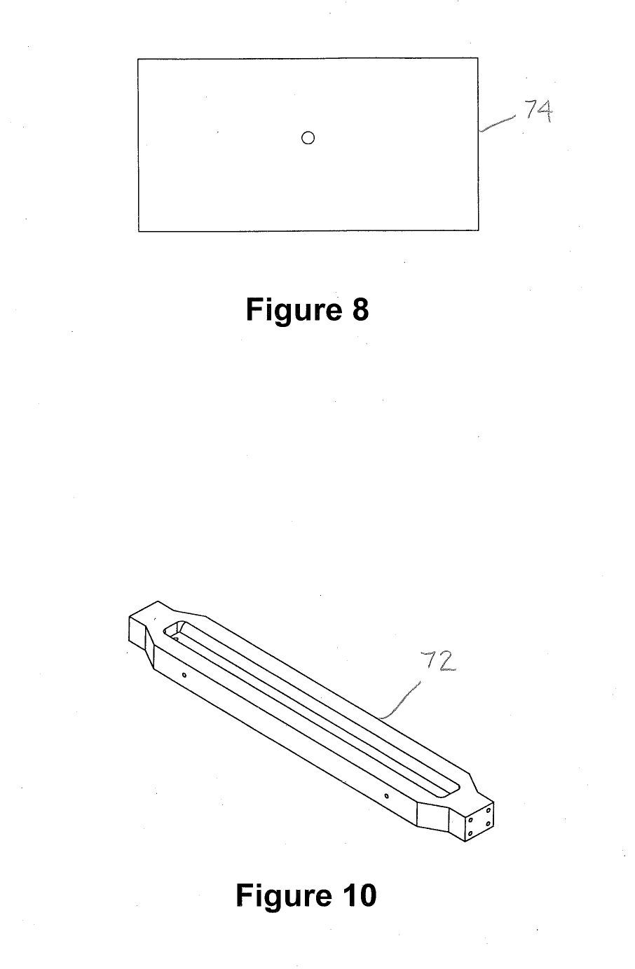

Referring now to FIG. 8, a front view of preferred toggle plate 74 of toggle plate/wedge adjust assembly 70 is illustrated. While FIG. 8 illustrates the preferred configuration and arrangement of the toggle plate, it is contemplated within the scope of the invention that the toggle plate may be of any suitable configuration and arrangement.

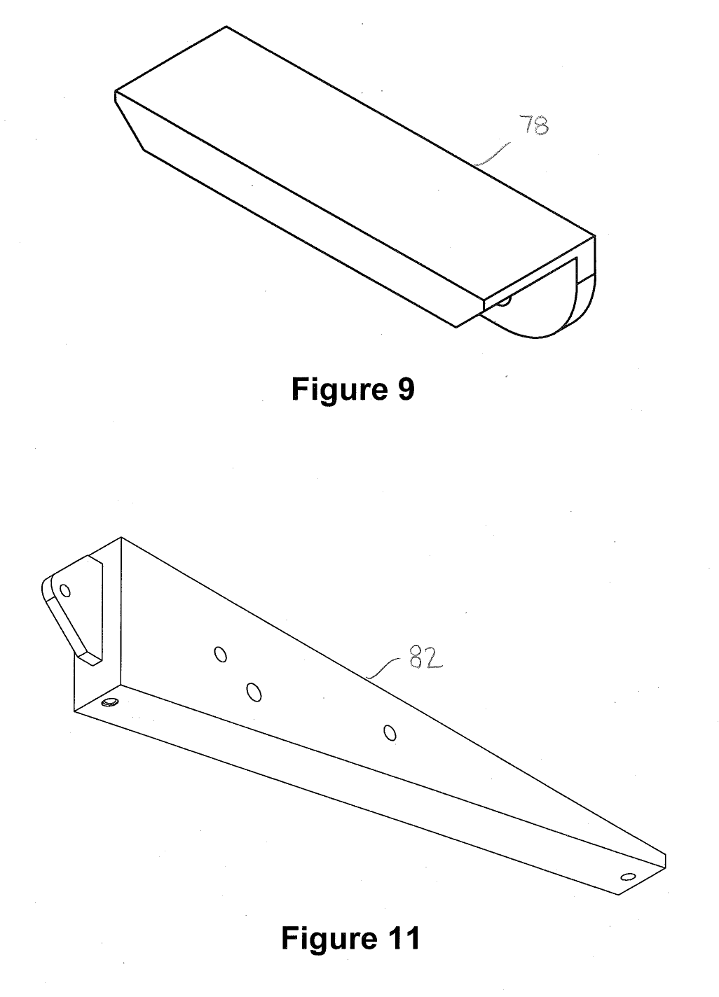

Referring now to FIG. 9, a perspective view of the preferred toggle block guide 78 of toggle plate/wedge adjust assembly 70 is illustrated. While FIG. 9 illustrates the preferred configuration and arrangement of the toggle block guide, it is contemplated within the scope of the invention that the toggle block guide may be of any suitable configuration and arrangement.

Referring now to FIG. 10, a perspective view of the preferred toggle block 72 of toggle plate/wedge adjust assembly 70 is illustrated. While FIG. 10 illustrates the preferred configuration and arrangement of the toggle block, it is contemplated within the scope of the invention that the toggle block may be of any suitable configuration and arrangement.

Referring now to FIG. 11, a perspective view of preferred adjusting wedge 82 of toggle plate/wedge adjust assembly 70 is illustrated. While FIG. 11 illustrates the preferred configuration and arrangement of the adjusting wedge, it is contemplated within the scope of the invention that the adjusting wedge may be of any suitable configuration and arrangement.

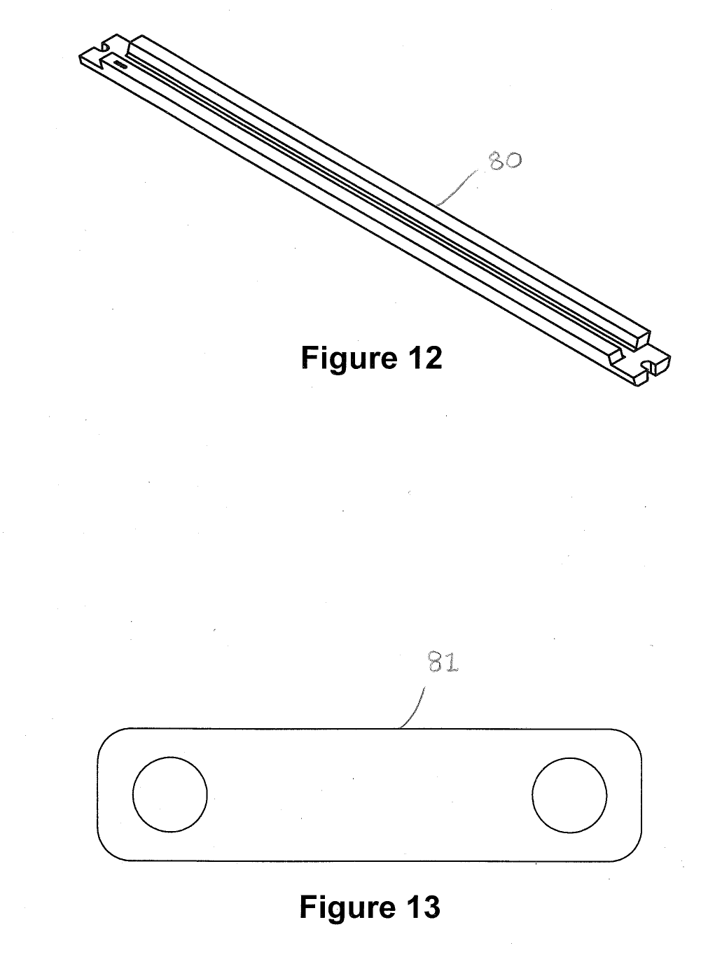

Referring now to FIG. 12, a front view of preferred wear seat 80 of toggle plate/wedge adjust assembly 70 is illustrated. While FIG. 12 illustrates the preferred configuration and arrangement of the wear seat, it is contemplated within the scope of the invention that the wear seat may be of any suitable configuration and arrangement.

Referring now to FIG. 13, a front view of the preferred wear seat retainer 81 of toggle plate/wedge adjust assembly 70 is illustrated. While FIG. 13 illustrates the preferred configuration and arrangement of the wear seat retainer, it is contemplated within the scope of the invention that the wear seat retainer may be of any suitable configuration and arrangement.

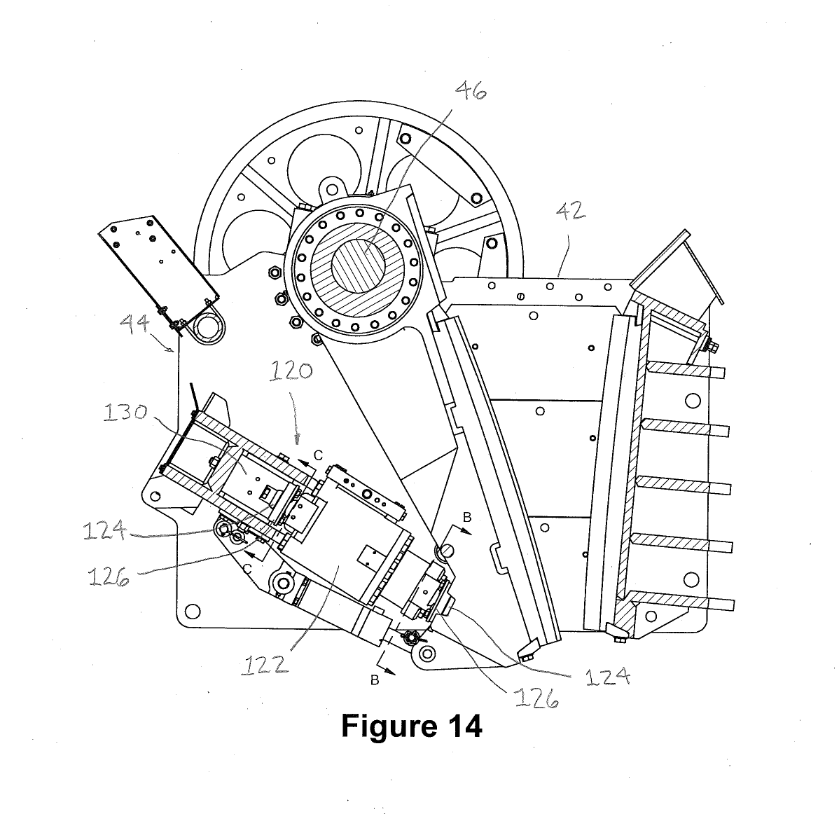

Referring now to FIG. 14, a sectional left side view of preferred rock crusher base 40 with a tramp iron relief system is illustrated. As shown in FIG. 14, the preferred tramp iron relief system is designated generally by reference numeral 120. Preferred tramp iron relief system 120 is mounted to rear section 44 of base frame 42 and eccentric shaft assembly 46. Preferred tramp iron relief system 120 comprises actuator assembly 122, wear seat seats 124, wear seat retainers 126, and mounting block 130. While FIG. 14 illustrates the preferred configuration and arrangement of the tramp iron relief system, it is contemplated within the scope of the invention that the tramp iron relief system may be of any suitable configuration and arrangement.

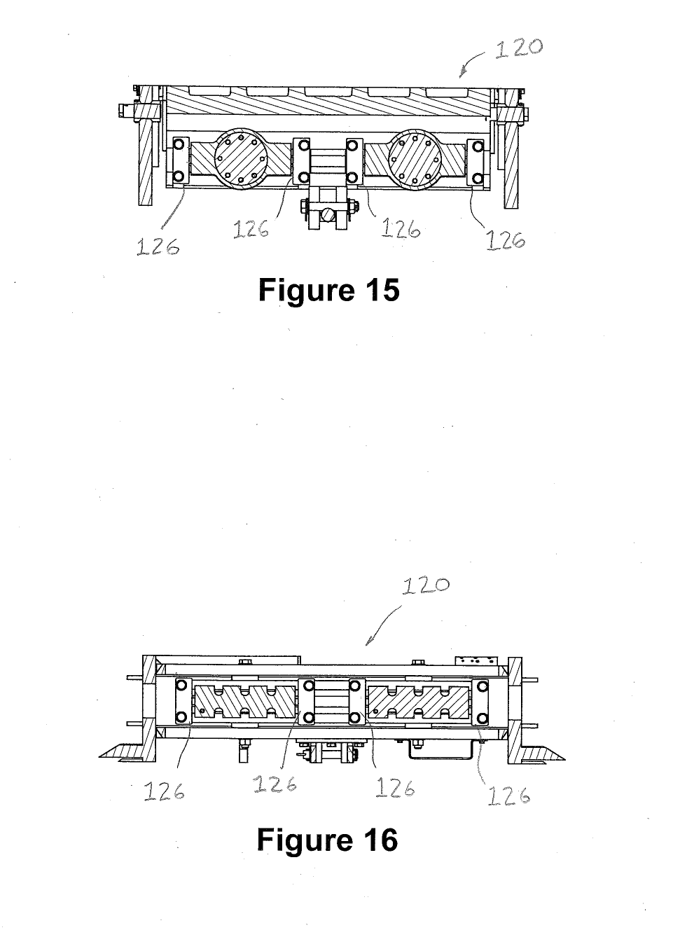

Referring now to FIG. 15, a sectional view of preferred tramp iron relief system 120 taken along line B-B of FIG. 14 is illustrated. As shown in FIG. 15, preferred tramp iron relief system 120 comprises a plurality of wear seat retainers 126.

Referring now to FIG. 16, a sectional detail view of preferred tramp iron relief system 120 taken along line C-C of FIG. 14 is illustrated. As shown in FIG. 16, preferred tramp iron relief system 120 comprises a plurality of wear seat retainers 126.

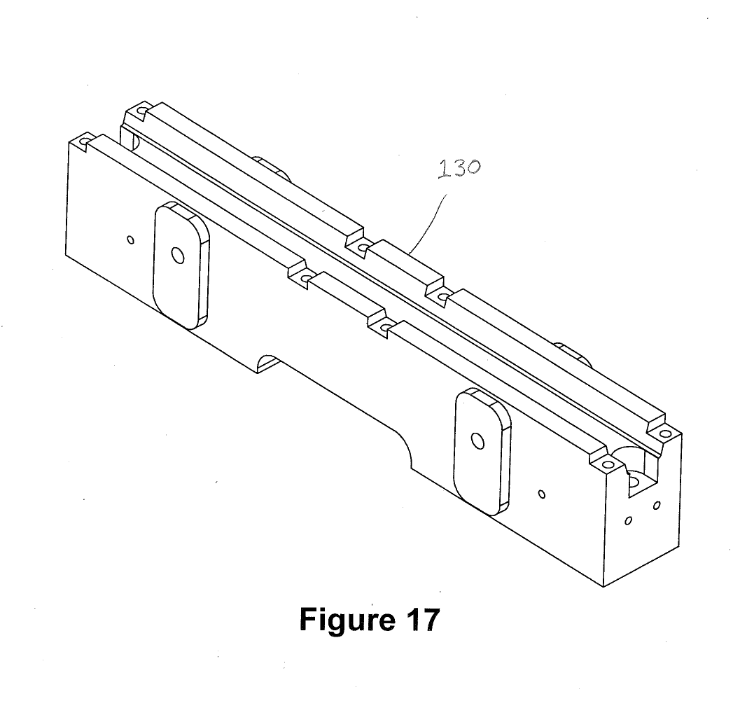

Referring now to FIG. 17, a perspective view of preferred mounting block 130 of tramp iron relief system 120 is illustrated. While FIG. 17 illustrates the preferred configuration and arrangement of the mounting block, it is contemplated within the scope of the invention that the mounting block may be of any suitable configuration and arrangement.

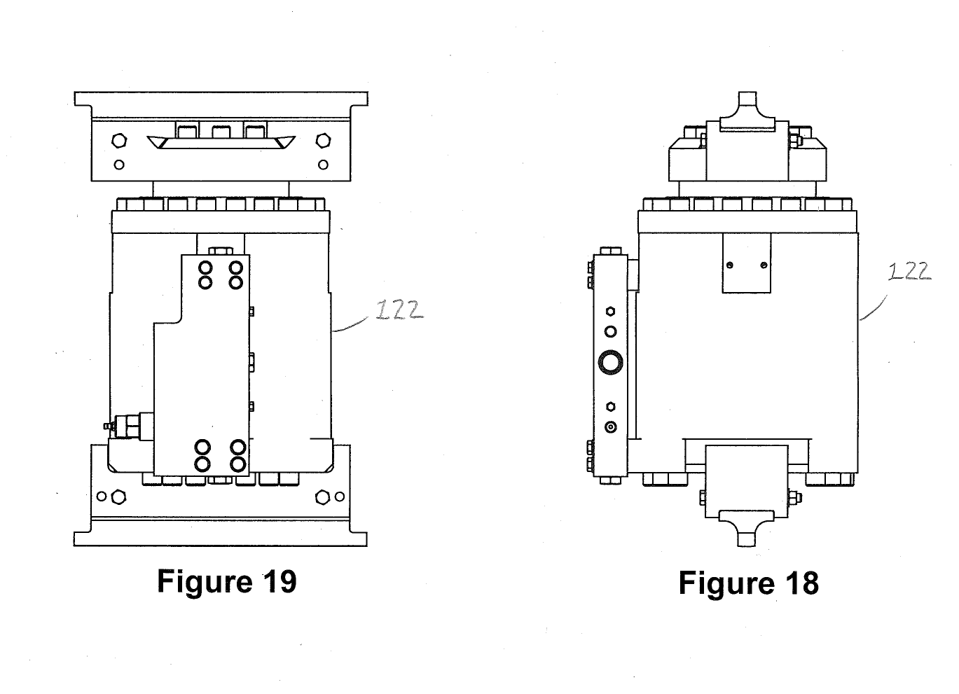

Referring now to FIG. 18, a front view of preferred actuator assembly 122 of tramp iron relief system 120 is illustrated. While FIG. 18 illustrates the preferred configuration and arrangement of the actuator assembly, it is contemplated within the scope of the invention that the actuator assembly may be of any suitable configuration and arrangement.

Referring now to FIG. 19, a right side view of preferred actuator assembly 122 of tramp iron relief system 120 is illustrated.

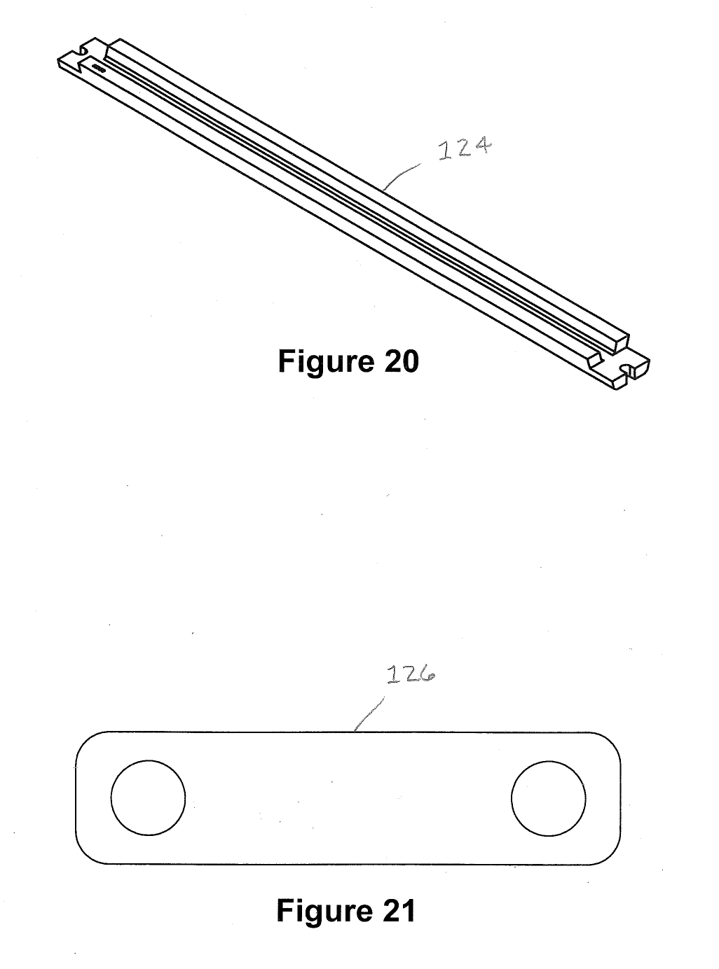

Referring now to FIG. 20, a perspective view of preferred wear seat 124 of tramp iron relief system 120 is illustrated. While FIG. 20 illustrates the preferred configuration and arrangement of the wear seat, it is contemplated within the scope of the invention that the wear seat may be of any suitable configuration and arrangement.

Referring now to FIG. 21, a front view of preferred wear seat retainer 126 of tramp iron relief system 120 is illustrated. While FIG. 21 illustrates the preferred configuration and arrangement of the wear seat retainer, it is contemplated within the scope of the invention that the wear seat retainer may be of any suitable configuration and arrangement.

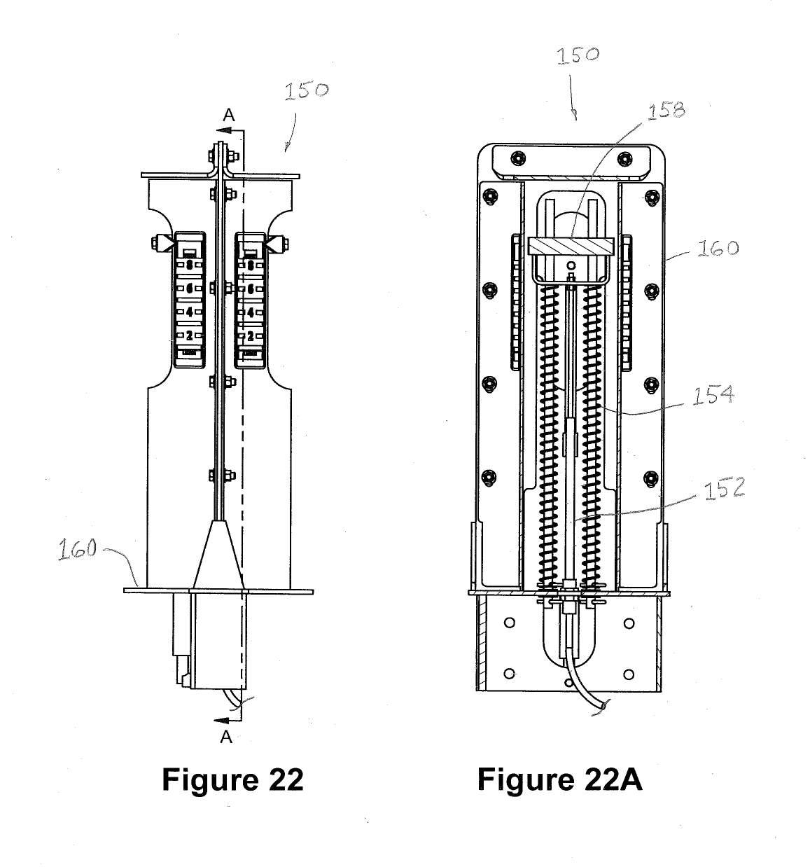

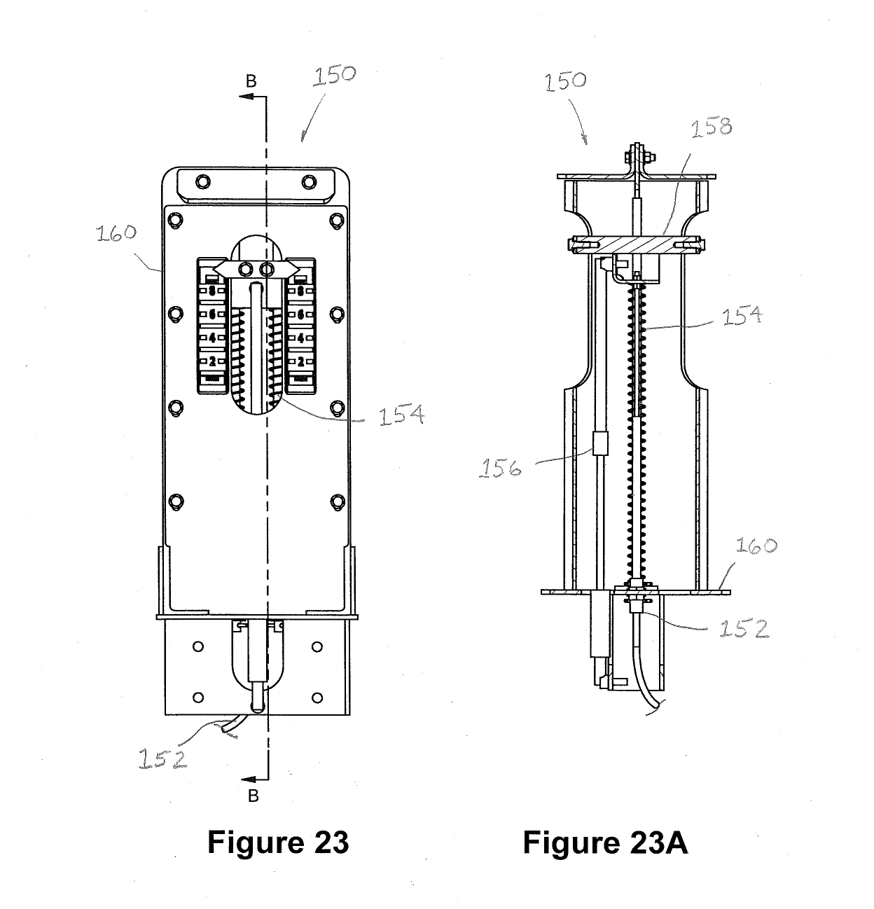

Referring now to FIG. 22, a front view of the preferred position indicator assembly is illustrated. As shown in FIG. 22, the preferred position indicator assembly is designated generally by reference numeral 150. Preferred position indicator assembly 150 is mounted remotely from actuator assembly 122 of the tramp iron relief system. Preferred position indicator assembly 150 comprises push pull cable 152, spring 154, weldment 158, and housing 160. Preferably, push pull cable 152 connects the movable part of position indicator assembly 150 with the actuator of the tramp iron relief system. Preferred position indicator assembly 150 moves down the distance that the actuator extends and provides a visual representation of the rock crusher jaw setting that can be read without having full controls. Preferred spring 154 pushes weldment 158 up and preferred push pull cable 152 pulls the weldment down. Preferred sensor 156 can be added internally to position indicator assembly 150 and connected to a control system to be read electronically. See FIG. 23A. While FIG. 22 illustrates the preferred configuration and arrangement of the position indicator assembly, it is contemplated within the scope of the invention that the position indicator assembly may be of any suitable configuration and arrangement.

Referring now to FIG. 22A, a sectional view of preferred position indicator assembly 150 taken along line A-A of FIG. 22 is illustrated. As shown in FIG. 22A, preferred position indicator assembly comprises push pull cable 152, spring 154, and housing 160.

Referring now to FIG. 23, a side view of preferred position indicator assembly 150 is illustrated. As shown in FIG. 23, preferred position indicator assembly 150 comprises push pull cable 152, spring 154, and housing 160.

Referring now to FIG. 23A, a sectional view of preferred position indicator assembly 150 taken along line B-B of FIG. 23 is illustrated. As shown in FIG. 23A, preferred position indicator assembly 150 comprises push pull cable 152, spring 154, sensor 156, weldment 158, and housing 160.

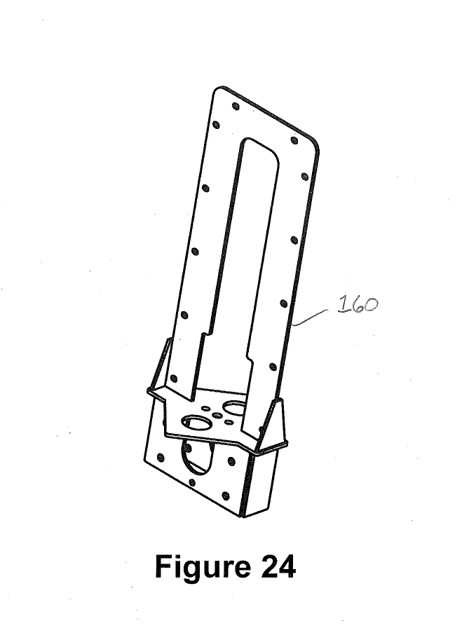

Referring now to FIG. 24, a perspective view of preferred position indicator assembly housing 160 is illustrated. While FIG. 24 illustrates the preferred configuration and arrangement of the position indicator assembly housing, it is contemplated within the scope of the invention that the position indicator assembly housing may be of any suitable configuration and arrangement.

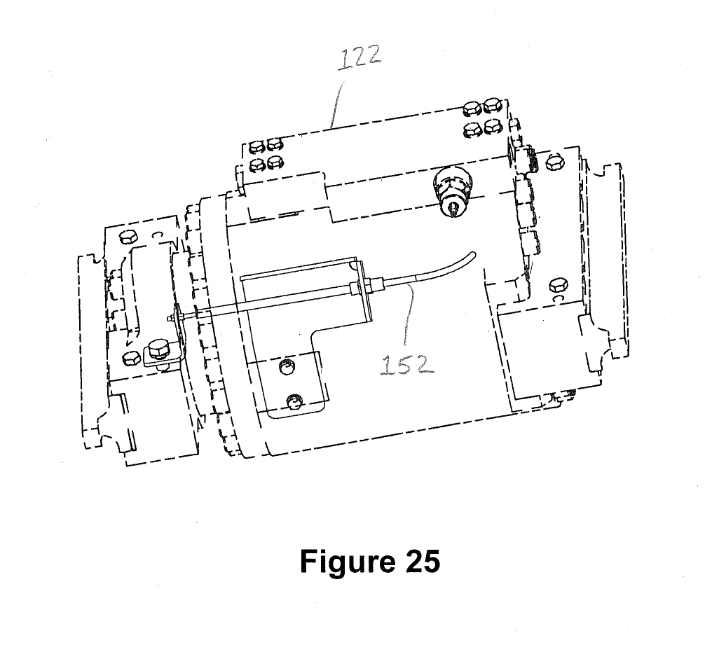

Referring now to FIG. 25, a perspective view of the preferred actuator assembly of the tramp iron relief system and the preferred push pull cable of the position indicator assembly is illustrated. As shown in FIG. 25, one end of preferred push pull cable 152 is connected to actuator assembly 122.

The invention also comprises a method for converting a rock crusher between a toggle plate/wedge adjust assembly and a tramp iron relief system. The preferred method comprises providing a rock crusher having a base frame with a rear section, an eccentric shaft assembly which is mounted on the base frame, and a common tension assembly which is housed in the rear section of the base frame. In the preferred embodiments of the rock crusher, the rear section of the base frame is configured to house a toggle plate/wedge assembly or a tramp iron relief system. The preferred method also comprises converting the rock crusher between a toggle plate/wedge adjust assembly and a tramp iron relief system.

In operation, several advantages of the preferred embodiments of the rock crusher are achieved. For example, the preferred embodiments of the rock crusher can use either a toggle plate/wedge adjust assembly or a tramp iron relief system. The preferred embodiments of the rock crusher are also easily converted between a toggle plate/wedge adjust assembly and a tramp iron relief system. The preferred embodiments of the rock crusher are more compact and less expensive. In addition, the preferred embodiments of the rock crusher indicate the position of the rock crusher in the absence of a full control system.

Although this description contains many specifics, these should not be construed as limiting the scope of the invention but as merely providing illustrations of some of the presently preferred embodiments thereof, as well as the best mode contemplated by the inventors of carrying out the invention. The invention, as described herein, is susceptible to various modifications and adaptations, and the same are intended to be comprehended within the meaning and range of equivalents of the appended claims.

What is claimed is:

1. A rock crusher, said rock crusher comprising:
(a) a base frame, said base frame having a rear section;
(b) an eccentric shaft assembly, said eccentric shaft assembly being mounted on the base frame; and
(c) a common tension assembly, said common tension assembly being housed in the rear section of the base frame;
wherein the rear section of the base frame is configured to house a toggle plate/wedge adjust assembly or a tramp iron relief system.

2. The rock crusher of claim 1 wherein the toggle plate/wedge adjust assembly is mounted to the rear section of base frame and the eccentric shaft assembly.

3. The rock crusher of claim 1 wherein the toggle plate/wedge adjust assembly comprises an actuator.

4. The rock crusher of claim 1 wherein the toggle plate/wedge adjust assembly comprises a wedge.

5. The rock crusher of claim 1 wherein the toggle plate/wedge adjust assembly comprises a toggle block.

6. The rock crusher of claim 1 wherein the toggle plate/wedge adjust assembly comprises a toggle plate.

7. The rock crusher of claim 1 wherein the toggle plate/wedge adjust assembly comprises a guide.

8. The rock crusher of claim 1 wherein the toggle plate/wedge adjust assembly comprises a retainer.

9. The rock crusher of claim 1 wherein the toggle plate/wedge adjust assembly comprises a wear seat.

10. The rock crusher of claim 1 wherein the tramp iron relief system is mounted to the rear section of the base frame and the eccentric shaft assembly.

11. The rock crusher of claim 1 wherein the tramp iron relief system comprises an actuator assembly.

12. The rock crusher of claim 1 wherein the tramp iron relief system comprises a retainer.

13. The rock crusher of claim 1 wherein the tramp iron relief system comprises wear seats.

14. The rock crusher of claim 1 further comprising a position indicator assembly.

15. The rock crusher of claim 11 wherein the position indicator assembly is mounted remotely from the actuator assembly.

16. The rock crusher of claim 10 wherein the position indicator assembly comprises a cable.

17. The rock crusher of claim 10 wherein the position indicator assembly comprises a spring.

18. The rock crusher of claim 10 wherein the position indicator assembly comprises a sensor.

19. A rock crusher, said rock crusher comprising:
(a) a base frame, said base frame having a rear section;
(b) an eccentric shaft assembly, said eccentric shaft assembly being mounted on the base frame;
(c) a common tension assembly, said common tension assembly being housed in the rear section of the base frame; and
(d) a position indicator assembly;
wherein the rear section of the base frame is configured to house a toggle plate/wedge adjust assembly or a tramp iron relief system.

20. A method for converting a rock crusher between a toggle plate/wedge adjust assembly and a tramp iron relief system, said method comprising:
(a) providing a rock crusher, said rock crusher comprising:
(i) a base frame, said base frame having a rear section;
(ii) an eccentric shaft assembly, said eccentric shaft assembly being mounted on the base frame;
(iii) a common tension assembly, said common tension assembly being housed in the rear section of the base frame;
wherein the rear section of the base frame is configured to house a toggle plate/wedge assembly or a tramp iron relief system;
(b) converting the rock crusher between a toggle plate/wedge adjust assembly and a tramp iron relief system.
